(19) United States
(12) Patent Application Publication
(10) Pub. No.: US 2022/0414693 A1
(43) Pub. Date: Dec. 29, 2022

(54) AUTOMATIC USER RETENTION SYSTEM

(71) Applicant: International Business Machines Corporation, Armonk, NY (US)

(72) Inventors: Lee A. Carbonell, Flower Mound, TX (US); Pandian Mariadoss, Allen, TX (US); Tsz S. Cheng, Grand Prairie, TX (US); Jeff Edgington, Fort Worth, TX (US)

(21) Appl. No.: 17/361,480

(22) Filed: Jun. 29, 2021

(51) Int. Cl. G06Q 30/02

(52) U.S. Cl. CPC G06Q 30/0203; G06Q 30/0211; G06Q 30/0224; G06Q 30/0201

(57) ABSTRACT

A system may include a memory and a processor in communication with the memory. The processor may be configured to perform operations. The operations may include receiving an opt-in from a user and detecting, automatically, an experience of the user. The operations may further include determining an impact potential of the experience and deciding a response strategy based on the impact potential. The operations may also include implementing the response strategy.

### BACKGROUND

The present disclosure relates to relational dynamics and more specifically to customer retention.

Customers may be rewarded with loyalty rewards programs. However, such loyalty rewards programs do not track or compensate inconveniences a customer might endure such as a long wait time resulting from a point of sales delay, an incorrect item included in an order, a meal incorrectly prepared, items being out of stock, and the like. Many customers do not take the time to complete a survey or complaint to notify the business about an inconvenience, and even those that do often receive boilerplate responses and no compensation.

### SUMMARY

Embodiments of the present disclosure include a system, method, and computer program product for empathetic engagement. The system may include a memory and a processor in communication with the memory. The processor may be configured to perform operations. The operations may include receiving an opt-in from a user and detecting, automatically, an experience of the user. The operations may further include determining an impact potential of the experience, deciding a response strategy based on the impact potential, and implementing the response strategy.

The above summary is not intended to describe each illustrated embodiment or every implement of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a device using a customer empathy system in accordance with some embodiments of the present disclosure.

FIG. 2 depicts a customer impact system in accordance with some embodiments of the present disclosure.

FIG. 3 illustrates a customer impact profile in accordance with some embodiments of the present disclosure.

FIG. 4 depicts interactions of a customer empathy system in accordance with some embodiments of the present disclosure.

FIG. 5 illustrates a block diagram of an example computing environment in which illustrative embodiments of the present disclosure may be implemented.

FIG. 6 depicts a block diagram of an example natural language processing system configured to analyze a recording to identify a particular subject of a query, in accordance with embodiments of the present disclosure.

FIG. 7 illustrates a cloud computing environment, in accordance with embodiments of the present disclosure.

FIG. 8 depicts abstraction model layers, in accordance with embodiments of the present disclosure.

FIG. 9 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to relational dynamics and more specifically to customer retention.

A business may not be aware of occurrences impacting customer experiences. In some circumstances, occurrences may be negative and incentivize customers to patronize other businesses and/or discourage others from using the business; such occurrences may be avoided if the business is aware of the negative occurrences and counteracts them. In some circumstances, occurrences may be positive, and the business may capitalize on the occurrence to solidify and/or affirm the positive experience in the mind of the customer.

Various occurrences may impact a business, and the business may be more capable of compensating for negative customer experiences and enhancing positive customer experiences if the business is aware of the occurrence that causes it. The business may not be aware of the severity of a particular issue as it may not be reflected in aggregate data. Some occurrences may cause customers to reduce or eliminate patronizing a business without indicating a reason (e.g., not submitting a complaint) when the customers might otherwise be retained if compensated for a negative experience. Proactively propitiating customers and/or validating customer concerns may assist in customer retention as well as reducing the likelihood of generating negative comments and/or reviews online. As a result, proactive measures may result in increased positive experiences by customers and the business.

Proactive measures may be enabled by mechanisms such as an end-to-end customer experience system that logs and/or tracks customer experience without the need for the customer to manually file input (e.g., a survey or complaint). The system may be able to provide insight on an individual level to enable the business to assess the potential impact of an experience and orchestrate a strategy for customer retention. In some embodiments of the present disclosure, the experience of the customer may be completed automatically.

The present disclosure discusses the detection and remediation of inconvenience at the level of an individual. The present disclosure may be used in a variety of situations with any data collection mechanisms capable of collecting individualized data. For example, in some circumstances, data may be collected via security monitoring cameras by identifying the restless body language of a customer physically present in a store; in other circumstances, natural language processing techniques may be used to identify patterns of distress of a customer in a phone transaction. Non-automatic data collection may also be used in lieu of or in conjunction with automated data collection. For example, a customer may complete a loyalty rewards program membership form and receive an affiliated loyalty card; the data on the form may be used to compile a profile for the customer which may be supplemented with the data from the transactions associated with the loyalty card.

Inconveniences detected at the individual level may be used to provide insight to a business, whether the data is aggregated or individually reported. The information may be used to estimate, calculate, or otherwise determine potential impact resulting from an experience with a particular customer. If a potential impact is determined to be negative, individualized data may be used to identify a strategy to remedy the situation to result in a net positive experience for the customer and thereby minimize the risk of negative impact on the business.

The strategy for remediation may be developed based on the data of the individual, including using customer data to construct a customer impact profile. Various techniques such as machine learning (ML) may be used to automatically develop the customer impact profile. A customer may opt in to data collection to enable a business to automatically compensate the customer for inconveniences and other negative experiences. The business may use the data to compensate the customer for negative experiences and to improve on experiences and prevent similar negative experiences in the future. For example, a business may provide a customized discount to a customer for a product being out of stock and use the data to order additional stock of that product to prevent a later inventory shortfall. The business may also use the aggregated data to identify insights about the business, customer experiences, remediation strategies, costs of remediation strategies, and the effectiveness of the remediation measures taken.

Customer experiences may be identified automatically such that a customer does not need to file a survey or complaint for the system to register an inconvenience. Data may be aggregated about a particular customer to determine the impact that an experience may have on the customer, such as whether similar prior inconveniences have resulted in the customer changing behavior with respect to in-store or online purchases, public social media comments, related decisions, and the like.

Personalized customer data may be aggregated with customer experience data to construct a customer profile which may identify customer behavior correlating with experiences and the remediation strategies attempted. Remediation strategies may include, for example, providing coupons, promotional items, experiences, speaking with a staff member, no action (e.g., to minimize the attention drawn to an inconvenience), and the like.

The present disclosure includes the utilization of the impact potential of individual customer experiences. In some embodiments, the negative impact potential of specific customers having certain experiences may be used to calculate how to best remedy a situation. For example, a customer may be likely to write a negative review of a business on a website because of a long wait time; the remediation to prevent the negative impact of that review for that particular customer may be a discount on the purchase. In the same example, another customer experiencing the same long wait time may be relieved at having the time to verify that everything from their shopping list made it into their cart; such a customer may not require a discount to prevent a negative impact.

The present disclosure discusses a system, method, and computer program product for empathetic engagement. The system may include a memory and a processor in communication with the memory. The processor may be configured to perform operations. The operations may include receiving an opt-in from a user and detecting, automatically, an experience of the user. The operations may further include determining an impact potential of the experience, deciding a response strategy based on the impact potential, and implementing the response strategy.

In some embodiments, the system includes developing a user impact profile for the user and tailoring the impact potential to the user based on the user impact profile.

In some embodiments, the system includes generating experience insight based on the experience and historical data.

In some embodiments, the system includes developing a user impact profile for the user and tailoring the experiences insight to the user based on the user impact profile. In some embodiments, the system further includes calculating a response strategy comparison from the user impact profile, wherein the comparison compares a plurality of response strategies, and identifying a preferred response strategy based on the response strategy comparison. In some embodiments, the system yet further includes updating the preferred response strategy based on additional data.

In some embodiments, the system includes calculating a potential consequence of the experience, computing a remediation cost, and comparing the potential consequence to the remediation cost. In some embodiments, the system further includes calculating a consequence comparison based on the potential consequence and the remediation cost. In some embodiments, the system yet further includes displaying the consequence comparison.

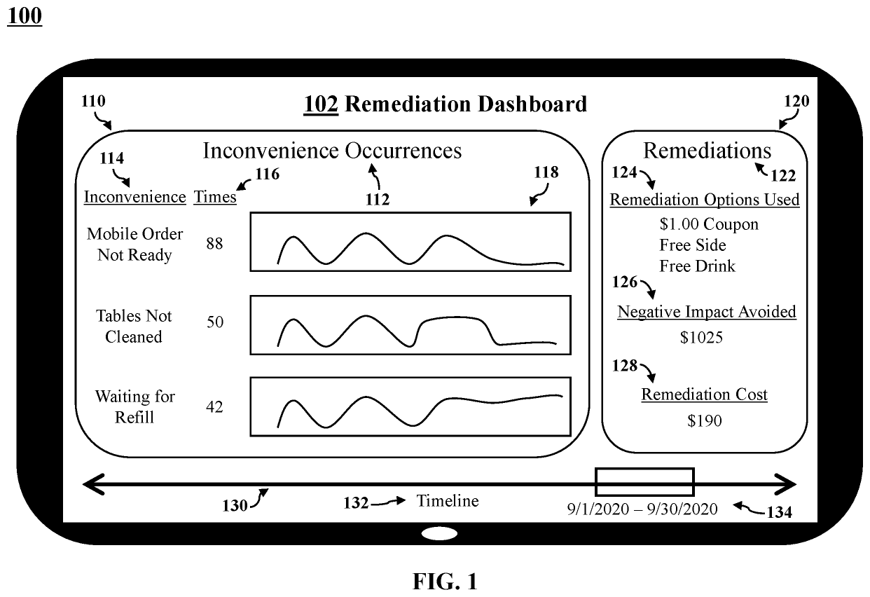

FIG. 1 illustrates a device 100 using a customer propitiation system in accordance with some embodiments of the present disclosure. The device 100 has a remediation dashboard 102 that displays inconvenience occurrences 110 and the remediations 120 taken to compensate customers for the inconveniences over a period of time 130.

The inconvenience occurrences 110 may be displayed with a title 112. The inconvenience occurrences 110 section may include a data table that includes inconvenience types 114, the number of times 116 the inconvenience type 114 occurred within a set time period 134, and a graphical display 118 of the inconvenience occurrences 110 over the set time period 134 selected. The set time period 134 may be selected from a timeline 130 which may have its own timeline title 132.

In some embodiments, the graphical display 118 and related data may enable a company using a customer propitiation system to identify and preemptively address likely inconveniences. For example, the trends in inconvenience occurrences 110 may show that there is a spike in all customer inconveniences during a certain shift change, and the system may recommend a pre-emptive action such as staggering the shift change.

The remediation dashboard 102 may further include information concerning remediations 120 which may include data about remediating actions available and historical impacts of individual remediation strategies (either in the aggregate or for a particular customer) and related financial information. In FIG. 1, remediations 120 includes a title 122. Data during the set time period 134 is also included, specifically, remediation options used 124, a calculated negative impact avoided 126 by employing the remediation options used 124, and the calculated remediation cost 128.

In some embodiments, the data in the remediations 120 section of the remediation dashboard 102 will be bound by the same set time period 134 as that describing the data about the inconvenience occurrences 110. In some embodiments, the inconvenience occurrences 110 and the remediations 120 sections may be bound by different time selections; for example, the inconvenience occurrences 110 may occur during one set time period 134 whereas the negative impact avoided 126 and remediation cost 128 may be realized during a subsequent time period, and a business may seek to project such information on the same remediation dashboard 102 and identify each as having a distinct set time period 134.

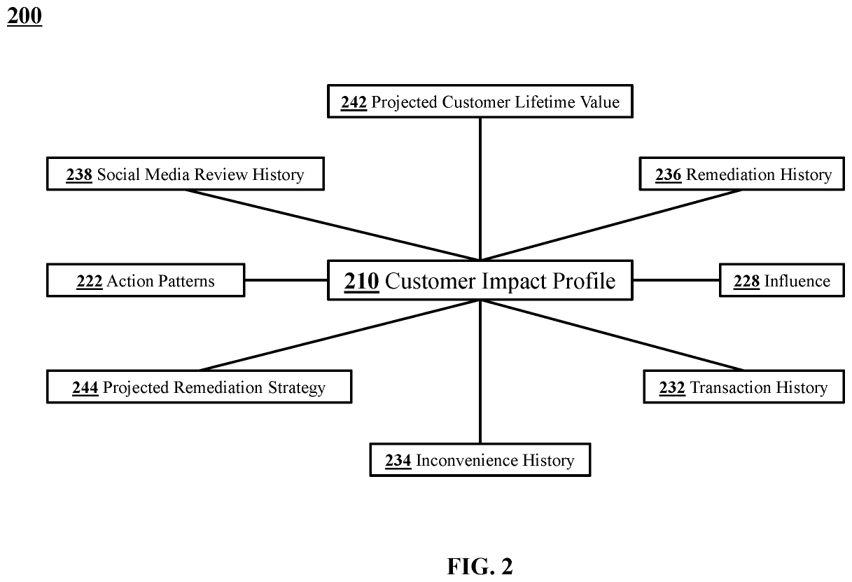

FIG. 2 depicts a customer impact system 200 in accordance with some embodiments of the present disclosure. The customer impact system 200 includes various components that may be used to establish (e.g., project or calculate) a customer impact profile 210. The components may include action patterns 222 and influence 228 of a customer. Action patterns 222 may include, for example, information about the efficacy of remediation strategies with a particular customer by gauging the behavior of a customer before and after an experience. Information for assessing action patterns 222 may include, for example, interpreting body language and tonal as available in security recordings.

The components may also include transaction history 232, inconvenience history 234, remediation history 236, and social media history 238 of a customer. Transaction history 232 may include, for example, monetary and other transactions (e.g., purchases and exchanges) with the entity employing the propitiation system; transaction history 232 may be correlated with any of the other factors individually or in the aggregate to identify trends and other relevant customer data such as, for example, the length of the relationship between a business and a customer and how one or more experiences changed a particular customer's behavior. In some embodiments, a point of sale terminal may record customer transaction data about a transaction with a customer, and the customer transaction data may be part of the transaction history 232 of the customer.

Inconvenience history 234 may include information relevant to the experiences of the customer with the entity employing the propitiation system. For example, the inconvenience history 234 could track the frequency of a customer experiencing delays at a point of sale, or the number of times a customer displayed irritated body language while searching for a product (which may indicate, for example, that a product was out of stock). Remediation history 236 may include the information about the remedies taken to remedy a negative experience or otherwise retain the customer. Remediation history 236 may include, for example, the remediation techniques used with the customer, the cost of various remediation techniques implemented, and the effectiveness thereof (e.g., an experience with a projected negative public review was changed to a neutral or positive public review as a result of the remediation technique implemented).

Social media review history 238 may include, for example, the current state of sentiment of a customer based on public-facing reviews. Such information may include, for example, whether feedback on social media is positive, neutral, or negative. Various technologies may be used to identify sentiment such as, for example, natural language (NL) processing, image recognition, and tonal analysis which may use artificial intelligence, including neural networks, to identify sentiments and sentiment trends of a customer.

The components may also include a projected customer lifetime value 242 and a projected remediation strategy 244. The projected lifetime value 242 of a customer may be a calculation of how the customer impacts the net revenue of a business. The projected lifetime value 242 may include how much the customer spends with an entity over time, referrals to others (e.g., likelihood of individual referrals and metadata about such referrals such as the impact profiles of the referred entities), the cost of acquiring the customer, what marketing programs were employed to incentivize the customer to patronize the business, retention costs, and the like. The projected lifetime value 242 of a customer may be a moving index that may be measured and changed over time based on such inputs. A projected remediation strategy 244 may include predictions as to what remediation techniques will most likely improve a customer experience with the entity based on, for example, the remediation history 236 of the customer and the impact that remediation history 236 had on the action patterns 222 of the customer.

The components of the customer impact profile 210 and the weights each of the components are given may be pre-set, automatically selected based on business profile, manually selected, or some combination thereof. For example, in some embodiments of the present disclosure, a business may decide to manually alter the customer impact profile 210 calculations to minimize the weight of the remediation history 236, maximize the weight of the transaction history 232, and eliminate the projected remediation strategy 244 component. Those with skill in the art will recognize the various implementations of such manual, automatic, and pre-set selections for weighting various factors. Additionally, other factors may be used to calculate the customer impact profile 210 as befits the goals of the entity utilizing the propitiation system.

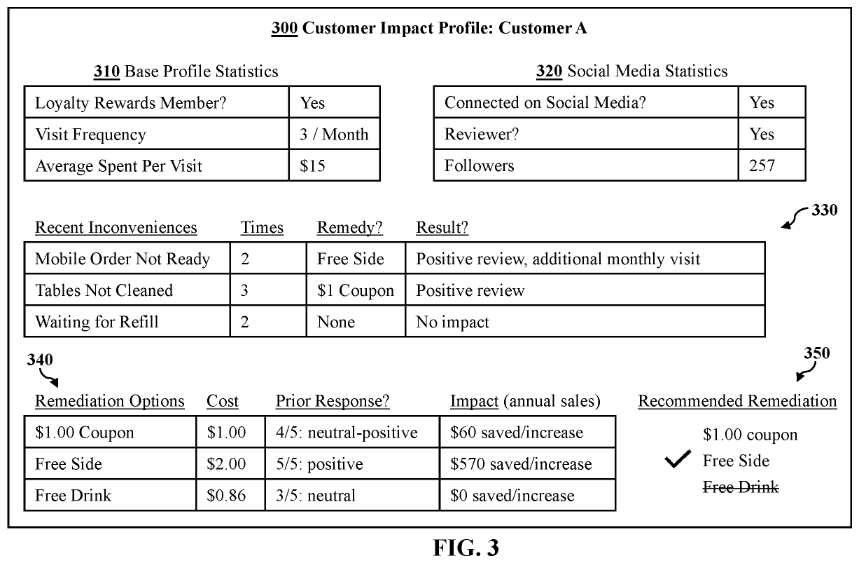

FIG. 3 illustrates a customer impact profile 300 in accordance with some embodiments of the present disclosure. The customer impact profile 300 may include base profile statistics 310, social media statistics 320, inconvenience history 330, remediation history 340, and recommended remediation 340.

Base profile statistics 310 may include whether the customer is a member of a loyalty program (e.g., a business rewards program), the frequency of a customer visiting a business (which may be for visiting a particular location, a business within a franchise, both, or some combination thereof), and the average amount the customer spends with the customer during each visit.

Social media statistics 320 may include whether the customer is connected to the business on social media (e.g., whether the customer is following the business on a website, or whether the customer is interacting with the posts of an entity), whether the customer posts reviews of companies, and how many followers the customer has.

Inconvenience history 330 may include the inconveniences a customer has faced (e.g., a mobile pick-up order not being ready at the selected pick-up time), tables not being clean at the time of visit, or waiting for restock of a particular item. The inconvenience history 330 may further include the remediating actions the business took to compensate the customer for any inconveniences and any results the remediating actions had on the behavior of the customer.

Remediation history 340 may include the remediation options the entity currently offers (e.g., a coupon, discount, or free add-on to an order), the cost of offering that remediation option, how the customer previously responded to the particular remedy, and the estimated impact on the business. Some customers may prefer certain incentives over other incentives, and the remediation history 340 may capture this data to identify which remedies are most likely to improve customer experience. Based on an individual customer's remediation history 340, other information in the customer impact profile 300, or more generalized data, a propitiation system may recommend remediation specific to that customer and/or inconvenience.

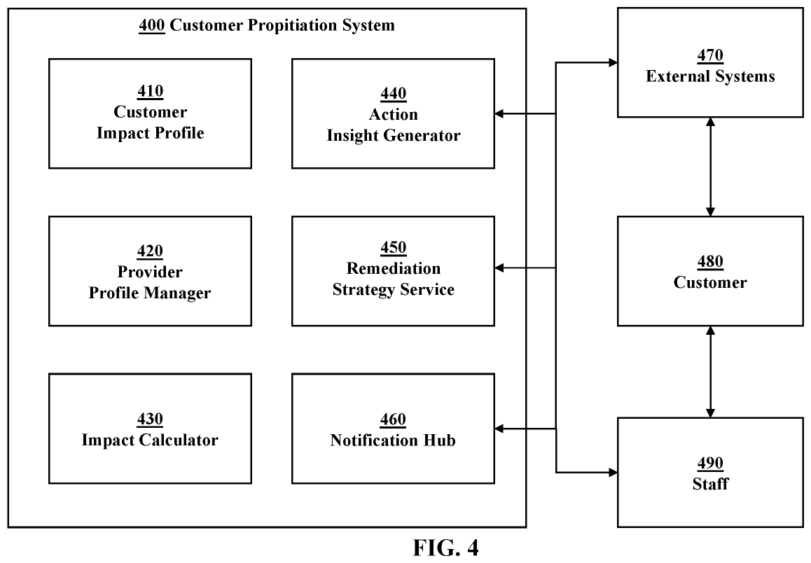

FIG. 4 depicts interactions of a customer propitiation system 400 in accordance with some embodiments of the present disclosure. The customer propitiation system 400 may include a customer impact profile 410 (as discussed in detail in FIG. 3), a provider profile manager 420, an impact calculator 430, an action insight generator 440, a remediation strategy service 450, and a notification hub 460.

The customer impact profile 410 may include base profile statistics, social media statistics, inconvenience history, remediation history, recommended remediation, and the like. The provider profile manager 420 may include, for example, the local history of a business (e.g., the history of a particular store or the stores of a franchise within a region), configurations for the business (e.g., particular rules, goals, and thresholds of the local store and/or franchise), remediation options, and the mapping of users and roles.

The action insights generator 440 may analyze data, metadata, and insights and index the information to original source systems such as store parameters. The impact calculator 430 may use information, such as information from the action insights generator 440, to measure customer experiences and project business impact. The impact calculator 430 may, for example, measure a current customer experience and consider the customer impact profile 410 of the customer (including social behaviors) to weigh the current context and calculate a projected impact on the business. The projected impact may include the projected difference between the action patterns of a customer if no remediating action is taken versus the action actions of the customer if one or more remediating actions are taken. Multiple avenues of projecting the impact may be used; for example, the result of various remediating actions may be compared to identify the optimal remedy for a customer given a particular inconvenience.

The remediation strategy service 450 may recommend or automatically implement one or more remediating actions. For example, the remediation strategy service 450 may identify an inconvenience to the customer 480 and automatically include a notification at a point of sale terminal for the staff 490 to offer a coupon, or the remediation strategy service 450 may even implement a discount automatically and instruct the staff 490 member (via a notification hub 460, for example) to announce the discount to the customer 480.

A notification hub 460 may be used to communicate data and/or insights from the data. The notification hub 460 may enable real-time intervention and/or communications. The notification hub 460 may be used for direct external communications with staff 490 (e.g., a message pop-up on a remediation dashboard 102 as shown in FIG. 1) or to internal/back-end systems (e.g., via an application programming interface funneling data to a business database).

The customer propitiation system 400 may interact with various external data sources and/or individuals who may use the data. For example, the customer propitiation system 400 may collect data from external systems 470 such as security cameras, operational data centers, transactional hardware, and scheduling/reservation services. External systems may identify whether a customer 480 is interacting with the entity (e.g., by placing or picking up an order) and whether the customer 480 is experiencing any inconveniences. The customer propitiation system 400 may additionally interact with staff 490 (e.g., a manager) to identify inconveniences and recommend a remediating action.

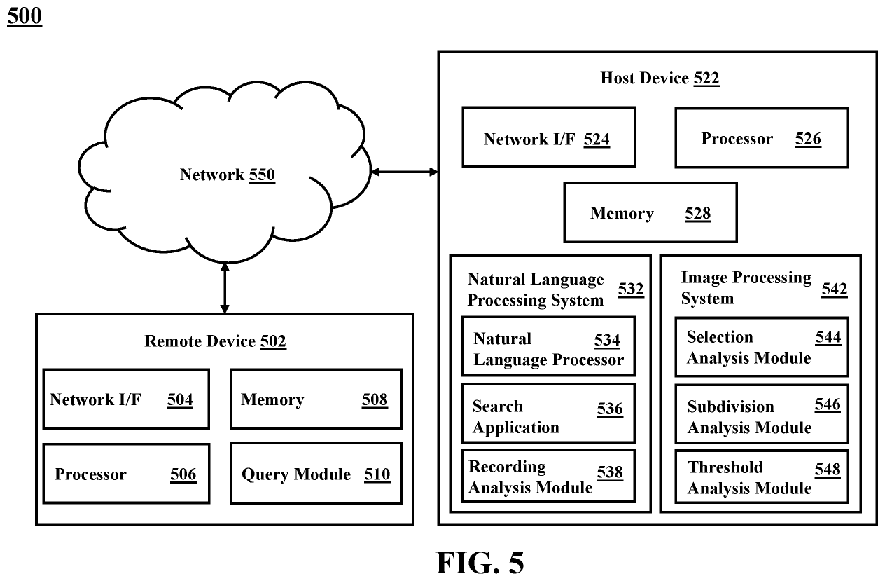

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 5, illustrated is a block diagram of an example computing environment 500 in which illustrative embodiments of the present disclosure may be implemented. In some embodiments, the computing environment 500 may include a remote device 502 and a host device 522.

Consistent with various embodiments of the present disclosure, the host device 522 and the remote device 502 may be computer systems. The remote device 502 and the host device 522 may include one or more processors 506 and 526 and one or more memories 508 and 528, respectively. The remote device 502 and the host device 522 may be configured to communicate with each other through an internal or external network interface 504 and 524. The network interfaces 504 and 524 may be modems or network interface cards. The remote device 502 and/or the host device 522 may be equipped with a display such as a monitor. Additionally, the remote device 502 and/or the host device 522 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 502 and/or the host device 522 may be servers, desktops, laptops, or hand-held devices.

The remote device 502 and the host device 522 may be distant from each other and communicate over a network 550. In some embodiments, the host device 522 may be a central hub from which remote device 502 can establish a communication connection, such as in a client-server networking model. Alternatively, the host device 522 and remote device 502 may be configured in any other suitable networking relationship (e.g., in a peer-to-peer configuration or using any other network topology).

In some embodiments, the network 550 can be implemented using any number of any suitable communications media. For example, the network 550 may be a wide area network (WAN), a local area network (LAN), an internet, or an intranet. In certain embodiments, the remote device 502 and the host device 522 may be local to each other and communicate via any appropriate local communication medium. For example, the remote device 502 and the host device 522 may communicate using a local area network (LAN), one or more hardwire connections, a wireless link or router, or an intranet. In some embodiments, the remote device 502 and the host device 522 may be communicatively coupled using a combination of one or more networks and/or one or more local connections. For example, the remote device 502 may be hardwired to the host device 522 (e.g., connected with an Ethernet cable) or the remote device 502 may communicate with the host device using the network 550 (e.g., over the Internet).

In some embodiments, the network 550 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 550.

In some embodiments, the remote device 502 may enable a user to input (or may input automatically with or without a user) a query (e.g., is any part of a recording artificial, etc.) to the host device 522 in order to identify subdivisions of a recording that include a particular subject. For example, the remote device 502 may include a query module 510 and a user interface (UI). The query module 510 may be in the form of a web browser or any other suitable software module, and the UI may be any type of interface (e.g., command line prompts, menu screens, graphical user interfaces). The UI may allow a user to interact with the remote device 502 to input, using the query module 510, a query to the host device 522, which may receive the query.

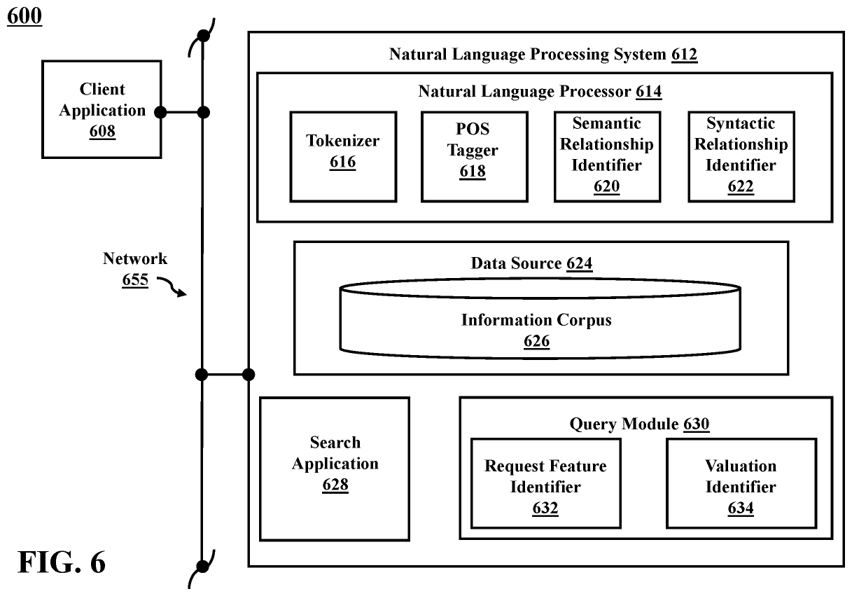

In some embodiments, the host device 522 may include a natural language processing system 532. The natural language processing system 532 may include a natural language processor 534, a search application 536, and a recording module 538. The natural language processor 534 may include numerous subcomponents, such as a tokenizer, a part-of-speech (POS) tagger, a semantic relationship identifier, and a syntactic relationship identifier. An example natural language processor is discussed in more detail in reference to FIG. 6.

The search application 536 may be implemented using a conventional or other search engine and may be distributed across multiple computer systems. The search application 536 may be configured to search one or more databases (e.g., repositories) or other computer systems for content that is related to a query submitted by the remote device 502. For example, the search application 536 may be configured to search dictionaries, papers, and/or archived reports to help identify a particular subject related to a query provided for a class. The recording analysis module 538 may be configured to analyze a recording to identify a particular subject (e.g., of the query). The recording analysis module 538 may include one or more modules or units, and may utilize the search application 536, to perform its functions (e.g., to identify a particular subject in a recording), as discussed in more detail in reference to FIG. 6.

In some embodiments, the host device 522 may include an image processing system 542. The image processing system 542 may be configured to analyze images associated with a recording to create an image analysis. The image processing system 542 may utilize one or more models, modules, or units to perform its functions (e.g., to analyze the images associated with the recording and generate an image analysis). For example, the image processing system 542 may include one or more image processing models that are configured to identify specific images related to a recording. The image processing models may include a section analysis module 544 to analyze single images associated with the recording and to identify the location of one or more features of the single images. As another example, the image processing system 542 may include a subdivision module 546 to group multiple images together identified to have a common feature of the one or more features. In some embodiments, image processing modules may be implemented as software modules. For example, the image processing system 542 may include a section analysis module and a subdivision analysis module. In some embodiments, a single software module may be configured to analyze the image(s) using image processing models.

In some embodiments, the image processing system 542 may include a threshold analysis module 548. The threshold analysis module 548 may be configured to compare the instances of a particular subject identified in a subdivision of sections of the recording against a threshold number of instances. The threshold analysis module 548 may then determine if the subdivision should be displayed to a user.

In some embodiments, the host device may have an optical character recognition (OCR) module. The OCR module may be configured to receive a recording sent from the remote device 502 and perform optical character recognition (or a related process) on the recording to convert it into machine-encoded text so that the natural language processing system 532 may perform NLP on the report. For example, a remote device 502 may transmit a video of a medical procedure to the host device 522. The OCR module may convert the video into machine-encoded text and then the converted video may be sent to the natural language processing system 532 for analysis. In some embodiments, the OCR module may be a subcomponent of the natural language processing system 532. In other embodiments, the OCR module may be a standalone module within the host device 522. In still other embodiments, the OCR module may be located on the remote device 502 and may perform OCR on the recording before the recording is sent to the host device 522.

While FIG. 5 illustrates a computing environment 500 with a single host device 522 and a remote device 502, suitable computing environments for implementing embodiments of this disclosure may include any number of remote devices and host devices. The various models, modules, systems, and components illustrated in FIG. 5 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze .GIFS to generate an image analysis.

It is noted that FIG. 5 is intended to depict the representative major components of an exemplary computing environment 500. In some embodiments, however, individual components may have greater or lesser complexity than as represented in FIG. 5, components other than or in addition to those shown in FIG. 5 may be present, and the number, type, and configuration of such components may vary.

Referring now to FIG. 6, shown is a block diagram of an exemplary system architecture 600 including a natural language processing system 612 configured to analyze data to identify objects of interest (e.g., possible anomalies, natural data, etc.), in accordance with embodiments of the present disclosure. In some embodiments, a remote device (such as remote device 502 of FIG. 5) may submit a text segment and/or a corpus to be analyzed to the natural language processing system 612 which may be housed on a host device (such as host device 522 of FIG. 5). Such a remote device may include a client application 608, which may itself involve one or more entities operable to generate or modify information associated with the recording and/or query that is then dispatched to a natural language processing system 612 via a network 655.

Consistent with various embodiments of the present disclosure, the natural language processing system 612 may respond to text segment and corpus submissions sent by a client application 608. Specifically, the natural language processing system 612 may analyze a received text segment and/or corpus (e.g., video, news article, etc.) to identify an object of interest. In some embodiments, the natural language processing system 612 may include a natural language processor 614, data sources 624, a search application 628, and a query module 630. The natural language processor 614 may be a computer module that analyzes the recording and the query. The natural language processor 614 may perform various methods and techniques for analyzing recordings and/or queries (e.g., syntactic analysis, semantic analysis, etc.). The natural language processor 614 may be configured to recognize and analyze any number of natural languages. In some embodiments, the natural language processor 614 may group one or more sections of a text into one or more subdivisions. Further, the natural language processor 614 may include various modules to perform analyses of text or other forms of data (e.g., recordings, etc.). These modules may include, but are not limited to, a tokenizer 616, a part-of-speech (POS) tagger 618 (e.g., which may tag each of the one or more sections of text in which the particular object of interest is identified), a semantic relationship identifier 620, and a syntactic relationship identifier 622.

In some embodiments, the tokenizer 616 may be a computer module that performs lexical analysis. The tokenizer 616 may convert a sequence of characters (e.g., images, sounds, etc.) into a sequence of tokens. A token may be a string of characters included in a recording and categorized as a meaningful symbol. Further, in some embodiments, the tokenizer 616 may identify word boundaries in a body of text and break any text within the body of text into their component text elements, such as words, multiword tokens, numbers, and punctuation marks. In some embodiments, the tokenizer 616 may receive a string of characters, identify the lexemes in the string, and categorize them into tokens.

Consistent with various embodiments, the POS tagger 618 may be a computer module that marks up a word in a recording to correspond to a particular part of speech. The POS tagger 618 may read a passage or other text in natural language and assign a part of speech to each word or other token. The POS tagger 618 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 618 may assign include, but are not limited to, comparative or superlative adverbs, wh-adverbs, conjunctions, determiners, negative particles, possessive markers, prepositions, wh-pronouns, and the like. In some embodiments, the POS tagger 618 may tag or otherwise annotate tokens of a recording with part of speech categories. In some embodiments, the POS tagger 618 may tag tokens or words of a recording to be parsed by the natural language processing system 612.

In some embodiments, the semantic relationship identifier 620 may be a computer module that may be configured to identify semantic relationships of recognized subjects (e.g., words, phrases, images, etc.) in a body of text/corpus. In some embodiments, the semantic relationship identifier 620 may determine functional dependencies between entities and other semantic relationships.

Consistent with various embodiments, the syntactic relationship identifier 622 may be a computer module that may be configured to identify syntactic relationships in a body of text/corpus composed of tokens. The syntactic relationship identifier 622 may determine the grammatical structure of sentences such as, for example, which groups of words are associated as phrases and which word is the subject or object of a verb. The syntactic relationship identifier 622 may conform to formal grammar.

In some embodiments, the natural language processor 614 may be a computer module that may group sections of a recording into subdivisions and generate corresponding data structures for one or more subdivisions of the recording. For example, in response to receiving a text segment at the natural language processing system 612, the natural language processor 614 may output subdivisions of the text segment as data structures. In some embodiments, a subdivision may be represented in the form of a graph structure. To generate the subdivision, the natural language processor 614 may trigger computer modules 616-622.

In some embodiments, the output of natural language processor 614 may be used by search application 628 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 624 of FIG. 6. In some embodiments, data sources 624 may include video libraries, data warehouses, information corpora, data models, and/or document repositories. In some embodiments, the data sources 624 may include an information corpus 626. The information corpus 626 may enable data storage and retrieval. In some embodiments, the information corpus 626 may be a subject repository that houses a standardized, consistent, clean, and integrated list of images and text. For example, an information corpus 626 may include teaching presentations that include step by step images and comments on how to perform a function. Data may be sourced from various operational systems. Data stored in an information corpus 626 may be structured in a way to specifically address reporting and analytic requirements. In some embodiments, an information corpus 626 may be a relational database.

In some embodiments, a query module 630 may be a computer module that identifies objects of interest within sections of a text, or other forms of data. In some embodiments, a query module 630 may include a request feature identifier 632 and a valuation identifier 634. When a query (e.g., survey, complaint, et cetera) is received by the natural language processing system 612, the query module 630 may be configured to analyze text using natural language processing to identify an object of interest (e.g., wait is too long, no refills, et cetera). The query module 630 may first identity one or more objects of interest in the text using the natural language processor 614 and related subcomponents 616-622. After identifying the one or more objects of interest, the request feature identifier 632 may identify one or more common objects of interest (e.g., anomalies, artificial content, natural data, etc.) present in sections of the text (e.g., the one or more text segments of the text). In some embodiments, the common objects of interest in the sections may be the same object of interest that is identified. Once a common object of interest is identified, the request feature identifier 632 may be configured to transmit the text segments that include the common object of interest to an image processing system (shown in FIG. 5) and/or to a comparator.

After identifying common objects of interest using the request feature identifier 632, the query module may group sections of text having common objects of interest. The valuation identifier 634 may then provide a value to each text segment indicating how close the object of interest in each text segment is related to one another (and thus indicates artificial and/or real data). In some embodiments, the particular subject may have one or more of the common objects of interest identified in the one or more sections of text. After identifying a particular object of interest relating to the query (e.g., identifying that one or more of the common objects of interest may be an anomaly), the valuation identifier 634 may be configured to transmit the criterion to an image processing system (shown in FIG. 4) and/or to a comparator (which may then determine the validity of the common and/or particular objects of interest).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

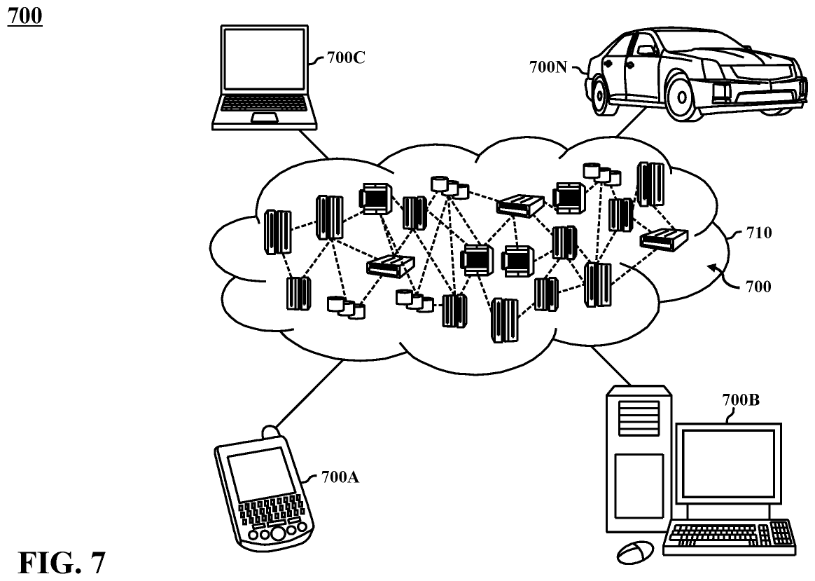

FIG. 7 illustrates a cloud computing environment 710 in accordance with embodiments of the present disclosure. As shown, cloud computing environment 710 includes one or more cloud computing nodes 700 with which local computing devices used by cloud consumers such as, for example, personal digital assistant (PDA) or cellular telephone 700A, desktop computer 700B, laptop computer 700C, and/or automobile computer system 700N may communicate. Nodes 700 may communicate with one another. They may be grouped (not shown) physically or virtually, in one or more networks, such as private, community, public, or hybrid clouds as described hereinabove, or a combination thereof.

This allows cloud computing environment 710 to offer infrastructure, platforms, and/or software as services for which a cloud consumer does not need to maintain resources on a local computing device. It is understood that the types of computing devices 700A-N shown in FIG. 7 are intended to be illustrative only and that computing nodes 700 and cloud computing environment 710 can communicate with any type of computerized device over any type of network and/or network addressable connection (e.g., using a web browser).

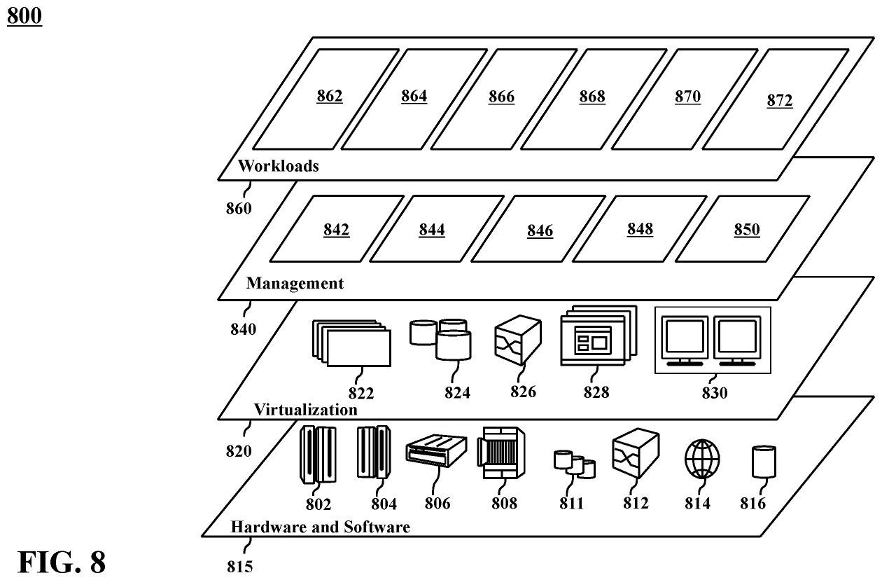

FIG. 8 illustrates abstraction model layers 800 provided by cloud computing environment 710 (FIG. 7) in accordance with embodiments of the present disclosure. It should be understood in advance that the components, layers, and functions shown in FIG. 8 are intended to be illustrative only and embodiments of the disclosure are not limited thereto. As depicted below, the following layers and corresponding functions are provided.

Hardware and software layer 815 includes hardware and software components. Examples of hardware components include: mainframes 802; RISC (Reduced Instruction Set Computer) architecture-based servers 804; servers 806; blade servers 808; storage devices 811; and networks and networking components 812. In some embodiments, software components include network application server software 814 and database software 816.

Virtualization layer 820 provides an abstraction layer from which the following examples of virtual entities may be provided: virtual servers 822; virtual storage 824; virtual networks 826, including virtual private networks; virtual applications and operating systems 828; and virtual clients 830.

In one example, management layer 840 may provide the functions described below. Resource provisioning 842 provides dynamic procurement of computing resources and other resources that are utilized to perform tasks within the cloud computing environment. Metering and pricing 844 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 846 provides access to the cloud computing environment for consumers and system administrators. Service level management 848 provides cloud computing resource allocation and management such that required service levels are met. Service level agreement (SLA) planning and fulfillment 850 provide pre-arrangement for, and procurement of, cloud computing resources for which a future requirement is anticipated in accordance with an SLA.

Workloads layer 860 provides examples of functionality for which the cloud computing environment may be utilized. Examples of workloads and functions which may be provided from this layer include: mapping and navigation 862; software development and lifecycle management 864; virtual classroom education delivery 866; data analytics processing 868; transaction processing 870; and a customer propitiation system 872.

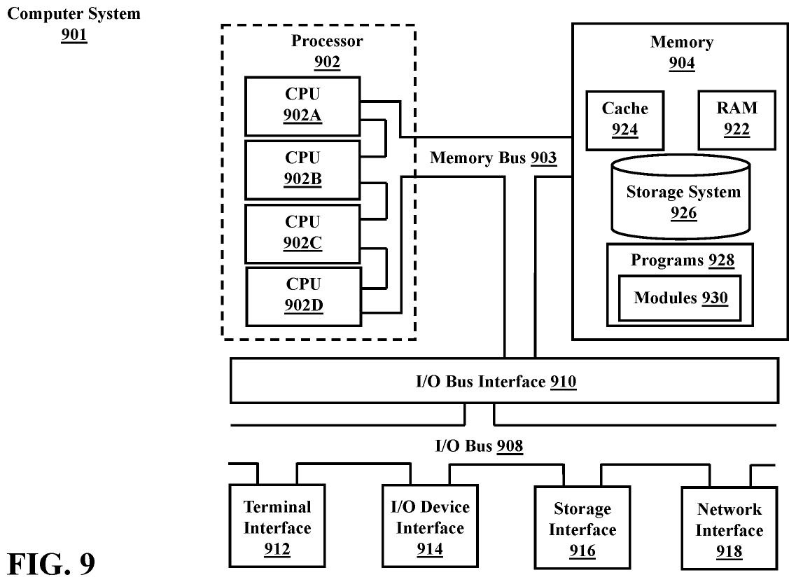

FIG. 9 illustrates a high-level block diagram of an example computer system 901 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 901 may comprise a processor 902 with one or more central processing units (CPUs) 902A, 902B, 902C, and 902D, a memory subsystem 904, a terminal interface 912, a storage interface 916, an I/O (Input/Output) device interface 914, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable CPUs 902A, 902B, 902C, and 902D, herein generically referred to as the CPU 902. In some embodiments, the computer system 901 may contain multiple processors typical of a relatively large system; however, in other embodiments, the computer system 901 may alternatively be a single CPU system. Each CPU 902 may execute instructions stored in the memory subsystem 904 and may include one or more levels of on-board cache.

System memory 904 may include computer system readable media in the form of volatile memory, such as random access memory (RAM) 922 or cache memory 924. Computer system 901 may further include other removable/non-removable, volatile/non-volatile computer system storage media. By way of example only, storage system 926 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 904 can include flash memory, e.g., a flash memory stick drive or a flash drive. Memory devices can be connected to memory bus 903 by one or more data media interfaces. The memory 904 may include at least one program product having a set (e.g., at least one) of program modules that are configured to carry out the functions of various embodiments.

One or more programs/utilities 928, each having at least one set of program modules 930, may be stored in memory 904. The programs/utilities 928 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 928 and/or program modules 930 generally perform the functions or methodologies of various embodiments.

Although the memory bus 903 is shown in FIG. 9 as a single bus structure providing a direct communication path among the CPUs 902, the memory subsystem 904, and the I/O bus interface 910, the memory bus 903 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units 910 are shown, which separate the I/O bus 908 from various communications paths running to the various I/O devices, in other embodiments some or all of the I/O devices may be connected directly to one or more system I/O buses 908.

In some embodiments, the computer system 901 may be a multi-user mainframe computer system, a single-user system, a server computer, or similar device that has little or no direct user interface but receives requests from other computer systems (clients). Further, in some embodiments, the computer system 901 may be implemented as a desktop computer, portable computer, laptop or notebook computer, tablet computer, pocket computer, telephone, smartphone, network switches or routers, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modification thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

1. A system, said system comprising:
a memory; and
a processor in communication with said memory, said processor being configured to perform operations, said operations comprising:
receiving an opt-in from a user;
developing a user impact profile for said user;
detecting, automatically, an experience of said user;
determining an impact potential of said experience;
deciding a response strategy based on said user impact profile, said experience, and said impact potential; and
implementing said response strategy.

2. The system of claim 1, further comprising:
tailoring said impact potential to said user based on said user impact profile.

3. The system of claim 1, further comprising:
generating experience insight based on said experience and historical data.

4. The system of claim 3, further comprising:
tailoring said experience insight to said user based on said user impact profile.

5. The system of claim 4, further comprising:
calculating a response strategy comparison from said user impact profile, wherein said comparison compares a plurality of response strategies; and
identifying a preferred response strategy based on said response strategy comparison.

6. The system of claim 5, further comprising:
updating said preferred response strategy based on additional data.

7. The system of claim 1, further comprising:
calculating a potential consequence of said experience;
computing a remediation cost; and
comparing said potential consequence to said remediation cost.

8. A method, said method comprising:
receiving an opt-in from a user;
developing a user impact profile for said user;
detecting, automatically, an experience of said user;
determining an impact potential of said experience;
deciding a response strategy based on said user impact profile, said experience, and said impact potential; and
implementing said response strategy.

9. The method of claim 8, further comprising:
tailoring said impact potential to said user based on said user impact profile.

10. The method of claim 8, further comprising:
generating experience insight based on said experience and historical data.

11. The method of claim 10, further comprising:
tailoring said experience insight to said user based on said user impact profile.

12. The method of claim 11, further comprising:
calculating a response strategy comparison from said user impact profile, wherein said comparison compares a plurality of response strategies; and
identifying a preferred response strategy based on said response strategy comparison.

13. The method of claim 12, further comprising:
updating said preferred response strategy based on additional data.

14. The method of claim 8, further comprising:
calculating a potential consequence of said experience;
computing a remediation cost; and
comparing said potential consequence to said remediation cost.

15. The method of claim 14, further comprising:
calculating a consequence comparison based on said potential consequence and said remediation cost.

16. The method of claim 15, further comprising:
displaying said consequence comparison.

17. A computer program product, said computer program product comprising a non-transitory computer readable storage medium having program instructions embodied therewith, said program instructions executable by a processor to cause said processor to perform a function, said function comprising:
receiving an opt-in from a user;
developing a user impact profile for said user;
detecting, automatically, an experience of said user;
determining an impact potential of said experience;
deciding a response strategy based on said user impact profile, said experience, and said impact potential; and
implementing said response strategy.

18. The computer program product of claim 17, further comprising:
tailoring said impact potential to said user based on said user impact profile.

19. The computer program product of claim 17, further comprising:
generating experience insight based on said experience and historical data.

20. The computer program product of claim 17, further comprising:
calculating a potential consequence of said experience;
computing a remediation cost; and
comparing said potential consequence to said remediation cost.
